(19) United States
(12) Patent Application Publication
(10) Pub. No.: US 2011/0116691 A1
(43) Pub. Date: May 19, 2011

(54) FACIAL SKIN DEFECT RESOLUTION SYSTEM, METHOD AND COMPUTER PROGRAM PRODUCT

(76) Inventors: Pao-Choo CHUNG, Tainan County (TW); Chuan-Yu Chang, Tainan County (TW); Chi-Lu Yang, Tainan County (TW); Shung-Cheng Li, Changhua City (TW); Jia-Sin Li, Changhua County (TW)

(21) Appl. No.: 12/635,344

(22) Filed: Dec. 10, 2009

(30) Foreign Application Priority Data
Nov. 13, 2009 (TW) 098138569

(51) Int. Cl. G06K 9/00

(52) U.S. Cl. 382/128

(57) ABSTRACT

A facial skin defect resolution system, method and a computer program product are presented. The system includes a storage module, a feature definition module, and a skin analysis module. The storage module stores at least one facial image of a user, at least one skin defect condition, and at least one of a plurality of facial feature conditions. The skin analysis module analyzes the facial image by using the facial feature conditions to obtain at least one facial skin area image, and then analyzes the facial skin area image according to the skin defect condition so as to mark a skin defect image in the facial skin area image.

### CROSS-REFERENCE TO RELATED APPLICATION

This application claims the benefit of Taiwan Patent Application No. 098138569, filed on Nov. 13, 2009, which is hereby incorporated by reference for all purposes as if fully set forth herein.

### BACKGROUND OF THE INVENTION

1. Field of Invention

The present invention relates to a facial skin defect resolution system, method and a computer program product, and more particularly to a facial skin defect resolution system, method and a computer program product for analyzing the facial skin defects in a facial image and positions thereof.

2. Related Art

In the prior art, a patient goes to a medical cosmetic sector for facial cosmetology, and is assisted in treating his/her facial skin by a professional doctor. In the medical care, the doctor first photographs the face of the patient with an image pickup device such as a camera or a video camera, so as to obtain pictures or images of different parts of the face of the patient, and selects some pictures or images presenting skin defect images like wrinkles, spots, and acne scars from them. For physical pictures, the parts presenting the skin defect images are circled with a sign pen or other color pens; while for digital images, the parts presenting the skin defect images are circled on a screen of a display module with a light pen or directly circled on the images by using a relevant image editing program. Afterwards, the doctor and the patient together evaluate and discuss about the parts requiring skin cosmetology and treatment.

However, the above operating mode consumes a lot of time and efforts for both sides, including the manual operation and time of the doctor for determining the skin defect parts, and even including the manual operation and time of the doctor for making medical process suggestions and postoperative predictions and evaluations as well as creating predicted resulting images for the patient. Therefore, how to accelerate the determination and treatment processes of facial cosmetic medical care so as to reduce the burden for the doctor and the patient should be considered by practitioners involved in cosmetic medical care.

### SUMMARY OF THE INVENTION

The present invention is directed to a facial skin defect resolution system and method for obtaining by analysis facial skin defects and positions thereof.

The present invention provides a facial skin defect resolution system, which includes: a storage module, for storing at least one facial image of a user, at least one skin defect condition, and at least one of a plurality of facial feature conditions; a feature definition module, for analyzing the facial image according to the facial feature conditions so as to obtain at least one facial skin area image; and a skin analysis module, for determining whether at least one skin defect image exists in the at least one facial skin area image by using the at least one skin defect condition, and if yes, marking the at least one skin defect image in the at least one facial skin area image.

The present invention provides a facial skin defect resolution method for solving the above problem, which is applicable to an electronic apparatus. The electronic apparatus at least includes a storage module for storing at least one skin defect condition and at least one of a plurality of facial feature conditions. The method includes: obtaining a facial image of a user; analyzing the facial image by using at least one of the plurality of facial feature conditions so as to obtain at least one facial skin area image; analyzing the at least one facial skin area image by using the at least one skin defect condition; determining whether at least one skin defect image exists or not; and marking the at least one skin defect image in the at least one facial skin area image when the at least one skin defect image exists.

The present invention further provides a facial skin defect resolution device, which includes: a case; an image pickup module, disposed outside the case for capturing a face of a user to form a facial image; a storage module, disposed inside the case for storing at least one skin defect condition and at least one of a plurality of facial feature conditions; a processing module, disposed inside the case and electrically coupled to the image pickup module and the storage module for analyzing the facial image according to the facial feature conditions so as to obtain at least one facial skin area image, and determining whether at least one skin defect image exists in the at least one facial skin area image by using the at least one skin defect condition, and if yes, marking the at least one skin defect image in the at least one facial skin area image; and a display module, disposed outside the case and electrically coupled to the processing module for displaying the facial image and the mark.

The present invention further provides a computer program product, for being read by an electronic apparatus to perform the facial skin defect resolution method. The implementation is illustrated above, and will not be described herein again.

The present invention is characterized in that, at least one skin defect condition and a plurality of facial feature conditions are pre-stored, such that the system is enabled to rapidly obtain relevant facial skin area images by using the facial feature conditions and facilitate the skin defect determination operation. Moreover, not only can the system automatically determine whether a skin defect image exists in the facial skin area image, but also determine a type of a skin defect displayed by the skin defect image by using the skin defect conditions, which helps to assist the doctor in the skin defect determination operation and greatly reduces the operation time for determining the type of the skin defect. In addition, the system also provides accurate skin defect information, which can be adopted by the doctor or an expert system to provide appropriate medical process suggestions, postoperative predictions and evaluations for the patient. Moreover, the system can generate a predicted resulting image after cosmetic medical care in combination with some graphics software. In this manner, the time and efforts required for both sides of the doctor and the patient are effectively reduced.

### BRIEF DESCRIPTION OF THE DRAWINGS

The present invention will become more fully understood from the detailed description given herein below for illustration only, and thus are not limitative of the present invention, and wherein:

FIG. 1A is a schematic architectural view of a facial skin defect resolution system in an embodiment of the present invention;

FIG. 1B is a schematic block diagram of the facial skin defect resolution system in the embodiment of the present invention;

FIG. 1C is a schematic block diagram of a facial skin defect resolution system in a second embodiment of the present invention;

FIG. 1D is a schematic view illustrating reception of a facial image in a third embodiment of the present invention;

FIG. 2 is a schematic view illustrating detection of a face range in the embodiment of the present invention;

FIG. 3 is a schematic view illustrating determination of facial features in the embodiment of the present invention;

FIG. 4A is a schematic view of a wrinkle image in the embodiment of the present invention;

FIG. 4B is a schematic view of a wrinkle mark image in the embodiment of the present invention;

FIG. 5A is a schematic view of a spot image in the embodiment of the present invention;

FIG. 5B is a schematic view of a spot mark image in the embodiment of the present invention;

FIG. 6A is a schematic view of an acne scar image in the embodiment of the present invention;

FIG. 6B is a schematic view of an acne scar mark image in the embodiment of the present invention;

FIG. 7A is a flow chart of a facial skin defect resolution method in the present invention;

FIG. 7B is a detailed flow chart of Step S 120 in the embodiment of the present invention;

FIG. 7C is a detailed flow chart of Step S122 in the embodiment of the present invention;

FIG. 7D is a flow chart of a wrinkle analysis embodiment in the present invention;

FIG. 7E is a flow chart of a spot analysis embodiment in the present invention;

FIG. 7F is a flow chart of an acne scar analysis embodiment in the present invention;

FIG. 7G is a flow chart illustrating establishment of an acne scar determination rule in the present invention;

FIG. 8A is a schematic architectural view of a facial skin defect resolution device in an embodiment of the present invention, and

FIG. 8B is a schematic block diagram of the facial skin defect resolution device in the embodiment of the present invention.

### DETAILED DESCRIPTION OF THE INVENTION

Preferred embodiments of the present invention are illustrated in detail below with the accompanying drawings.

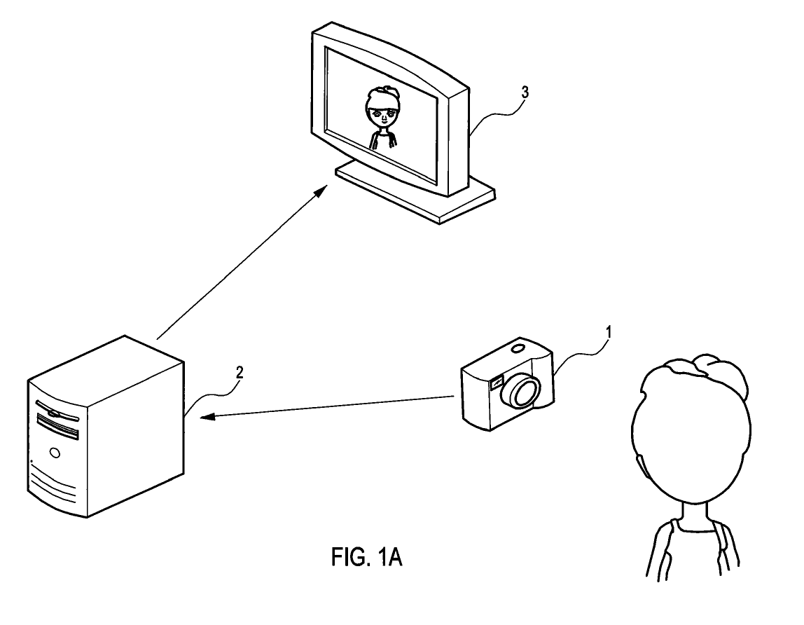

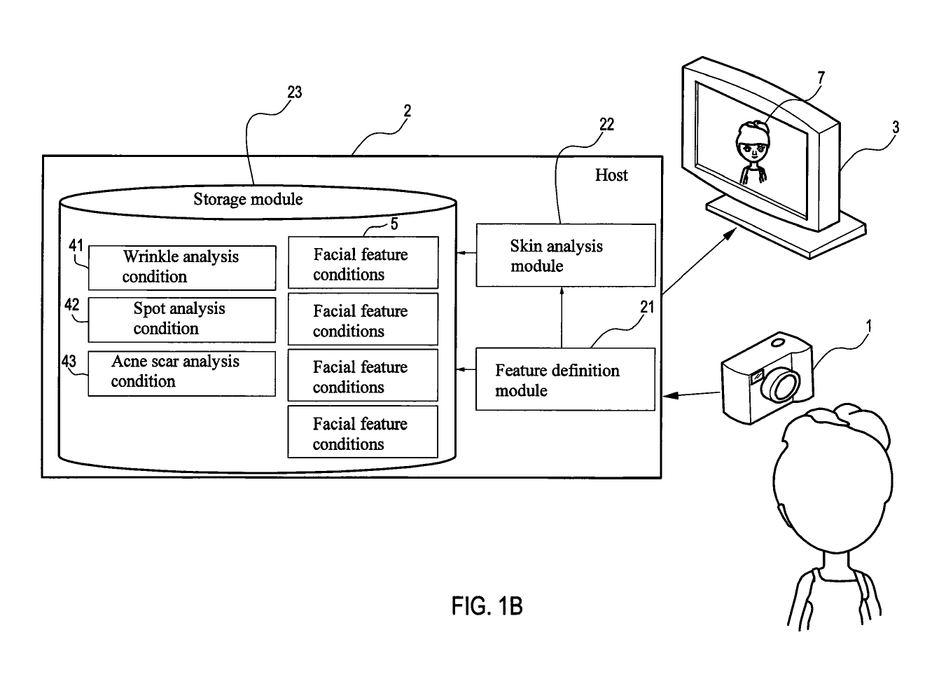

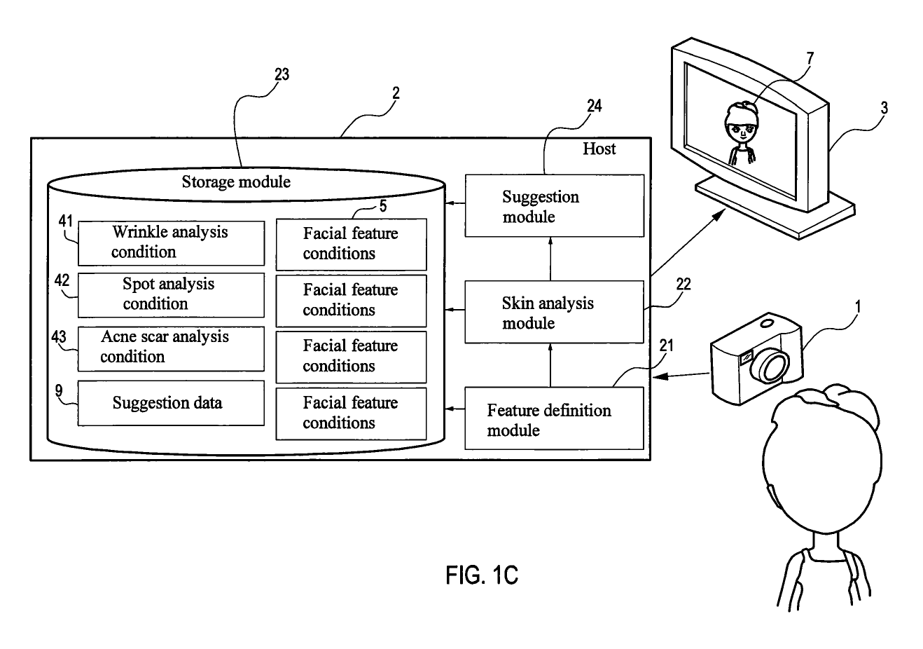

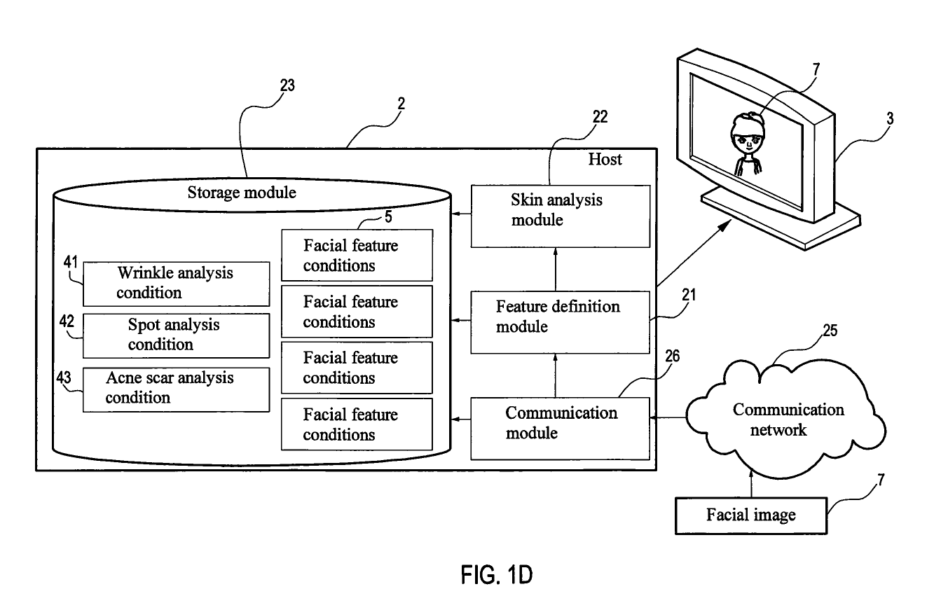

FIG. 1A is a schematic architectural view of a facial skin defect resolution system in an embodiment of the present invention, and FIG. 1B is a schematic block diagram of the facial skin defect resolution system in the embodiment of the present invention. This embodiment is applicable to an electronic apparatus which is illustrated as, but not limited to, a host 2 in this embodiment. In other embodiments, the electronic apparatus may also be a personal computer (PC), a notebook computer, a Kiosk, a personal digital assistant (PDA), or a smart phone. The facial skin defect resolution system in this embodiment mainly includes a host 2. The host 2 includes a storage module 23, a feature definition module 21, and a skin analysis module 22. In addition, the host 2 may be further connected to a display module 3 for displaying the images or patterns, further including the variations in the process and marks of a facial image.

In other embodiments, the facial skin defect resolution system may also include an image pickup module 1 for capturing a face of a user to form at least one facial image, which is illustrated as a facial image 7 in this embodiment. The image pickup module 1 is, but not limited to, a digital camera or a digital video camera, as long as it is an image pickup device capable of forming a digital image after capturing a scene.

The storage module 23 is used for storing at least one skin defect condition and at least one of a plurality of facial feature conditions 5. The storage module 23 may be electrically coupled to the image pickup module 1 so as to obtain and store the facial image transferred from the image pickup module or obtain a facial image transferred from afar via other storage media or a network communication. In this embodiment, the skin defect includes, for example, a wrinkle, a spot, and an acne scar, and thus the skin defect condition includes a wrinkle analysis condition 41, a spot analysis condition 42, and an acne scar analysis condition 43, but is not limited thereto. Other relevant skin defects are also applicable. In this embodiment, facial features include eyes, eyebrows, a nose, and a lip, and the corresponding facial feature conditions 5 thereof will be illustrated later.

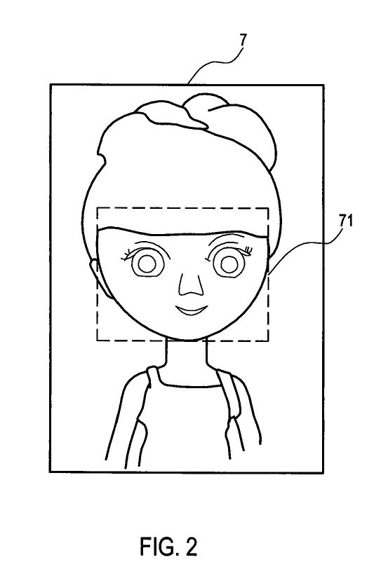

FIG. 2 is a schematic view illustrating detection of a face range of the facial image in the present invention. The feature definition module 21 finds the face range 71 in the facial image 7 by using a face detection technology, and removes the part irrelevant to the face of the user to obtain an image of the face range 71 in the facial image 7.

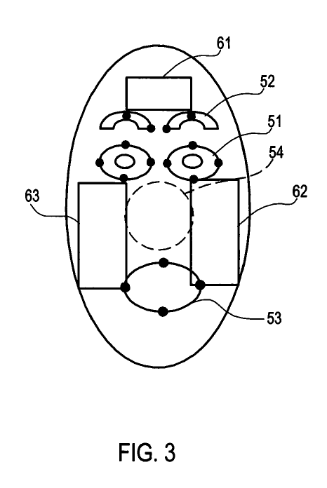

FIG. 3 is a schematic view illustrating determination of the facial features in the embodiment of the present invention. The facial feature conditions 5 are displayed herein as patterns, including an eye pattern 51, a lip pattern 53, an eyebrow pattern 52, and a nose pattern 54. The feature definition module 21 analyzes the facial image 7 by using the facial feature conditions 5 pre-stored in the storage module 23 so as to find the feature images presented by the facial features in the facial image 7, for example, a shape of the eyes and a pattern position thereof in the facial image 7, a shape of the eyebrows and a pattern position thereof in the facial image 7, and a shape of the lip and a pattern position thereof in the facial image 7. Afterwards, the feature definition module 21 deduces a position of the nose pattern 54 (i.e., a position of the nose pattern 54 in the facial image 7) by using the position of the eye pattern 51, the position of the lip pattern 53, and the position of the eyebrow pattern 52. Then, the feature definition module 21 finds in the facial image 7 at least one skin area different from the facial feature conditions 5 by using the facial feature conditions 5 and the skin area includes, for example, but is not limited to, a forehead skin area, a left cheek skin area, and a right cheek skin area. Finally, the feature definition module 21 determines an image of the skin area as a facial skin area image which is part of the facial image. Here, the facial skin area image is taken from part of the facial image, and therefore the facial skin area image is part of the facial image. In this embodiment, a forehead skin area image 61, a left cheek skin area image 62, and a right cheek skin area image 63 are formed.

The skin analysis module 22 analyzes the facial skin area images by using the skin defect condition pre-stored in the storage module 23 so as to determine whether at least one skin defect image exists in each facial skin area image. Here, the skin defect image is taken from part of the part of the facial skin area image, and therefore the skin defect image is part of the facial skin area image. The skin defect condition in this embodiment includes at least one selected from a group consisting of the wrinkle analysis condition 41, the spot analysis condition 42, and the acne scar analysis condition 43.

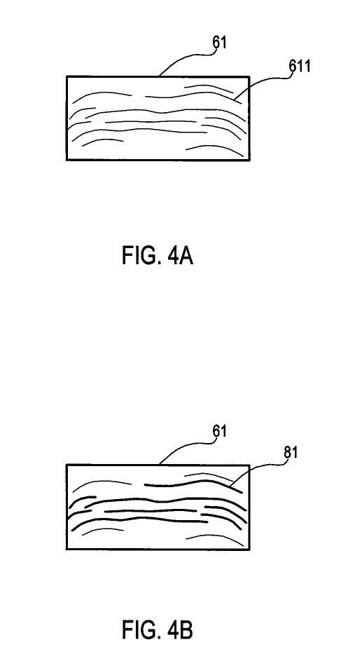

FIG. 4A is a schematic view of a wrinkle image in the present invention, and FIG. 4B is a schematic view of a wrinkle mark image in the present invention. If the skin defect condition includes the wrinkle analysis condition 41, the skin analysis module 22 analyzes every pixel data of each facial skin area image, and determines whether a plurality of dark pixels exist, and whether the dark pixels form at least one continuous line. As for the forehead skin area image 61, if the skin analysis module 22 determines that the continuous line exists in the forehead skin area image 61, the skin analysis module 22 determines that the continuous line is a wrinkle 611 and puts a mark 81 on the wrinkle 611, such as marks the wrinkle 611 as the skin defect image in the facial skin area image.

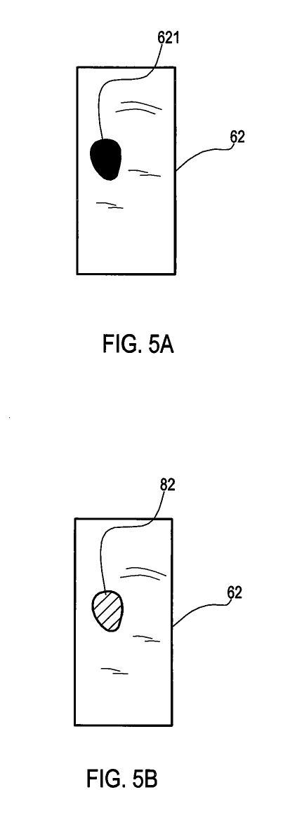

FIG. 5A is a schematic view of a spot image in the present invention, and FIG. 5B is a schematic view of a spot mark image in the present invention. If the skin defect condition includes the spot analysis condition 42, the skin analysis module 22 analyzes every pixel data of each facial skin area image, and determines whether a plurality of dark pixels exist and whether the dark pixels form at least one dark block. As for the left cheek skin area image 62, if the skin analysis module 22 determines that the dark block exists, the skin analysis module 22 further determines that the dark block is a spot pattern 621 and puts a mark 82 on the spot pattern 621, such as marks the spot pattern 621 as the skin defect image in the facial skin area image.

It should be noted herein that, the dark pixel presents a skin luster deeper than that of a normal skin color, and has a degree of luster higher than an adaptive threshold. The adaptive threshold may be a system default value or preset by an operator via a man-machine interface of the system.

Further, the skin analysis module 22 adjusts a glossiness of the facial skin area image so that the skin color presented by the facial skin area image is adjusted to conform to a skin sample image, thereby preventing the facial skin area image from presenting a skin color different from the skin sample image due to the influence of the optical brightness of the photographing environment and avoiding interference with the analysis operation of the skin defect.

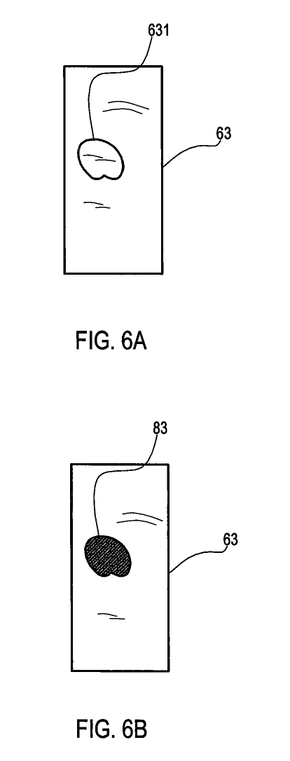

FIG. 6A is a schematic view of an acne scar image in the present invention, and FIG. 6B is a schematic view of an acne scar mark image in the present invention. If the skin defect condition includes the acne scar analysis condition 43, the skin analysis module 22 analyzes every pixel data of each facial skin area image, and determines whether a plurality of abnormal pixel data exists and the abnormal pixel data form at least one scar block. As for the right cheek skin area image 63, when the skin analysis module 22 determines that the scar block exists, the skin analysis module 22 introduces the scar block into an acne scar determination rule so as to determine whether the scar block is an acne scar pattern 631, and if yes, puts a mark 83 on the acne scar pattern 631 on the facial skin area image, such as marks the acne scar pattern 631 as the skin defect image in the facial skin area image.

It should be noted herein that, the abnormal pixel data includes color data different from that included in normal pixel data, that is, the abnormal pixel data presents a skin luster different from that of the normal skin color.

In addition, the acne scar has no particular shape or luster. In order to improve the accuracy of the acne scar determination rule, the acne scar determination rule may be established by a plurality of acne scar pattern samples in combination with a neural network. During the establishment, acne scar features are first extracted from the acne scar pattern samples, and then introduced into the neural network. Detection and calculation are performed on the acne scar features by using self-learning, inductive inference, parallel computation, and other characteristics of the neural network, so as to generate an acne scar determination network corresponding to the acne scar features, and the acne scar determination network is regarded as the acne scar determination rule. The skin analysis module 22 determines whether the scar block is the acne scar pattern 631 upon introducing the scar block into the acne scar determination network.

If the skin analysis module 22 determines that none of the facial skin area images has the skin defect image according to the skin defect condition, the skin analysis module 22 does not put any mark on the facial skin area images and determines that the facial skin of the user corresponding to the facial skin area images has no defect.

FIG. 1C is a schematic block diagram of a facial skin defect resolution system in a second embodiment of the present invention. The difference between this embodiment and the embodiment shown in FIGS. 1A and 1B lies in that, the system of this embodiment further includes a suggestion module 24, the storage module 23 further stores at least one suggestion data 9 corresponding to the aforementioned skin defect condition, and the suggestion module 24 is disposed in the system, which is a single independent apparatus or established inside the host 2. After the skin defect image is marked, the suggestion module 24 generates the corresponding suggestion data 9 according to a type of the skin defect image, a type of the mark, and the skin defect condition used for determining the skin defect image.

FIG. 1D is a schematic view illustrating reception of the facial image in a third embodiment of the present invention. The difference between this embodiment and the embodiment shown in FIGS. 1A and 1B lies in that, the system of this embodiment further includes a communication module 26 linked to a communication network 25 (including an Internet, a telecommunication network, or a local area network) so as to receive and store the facial image 7 into the storage module 23.

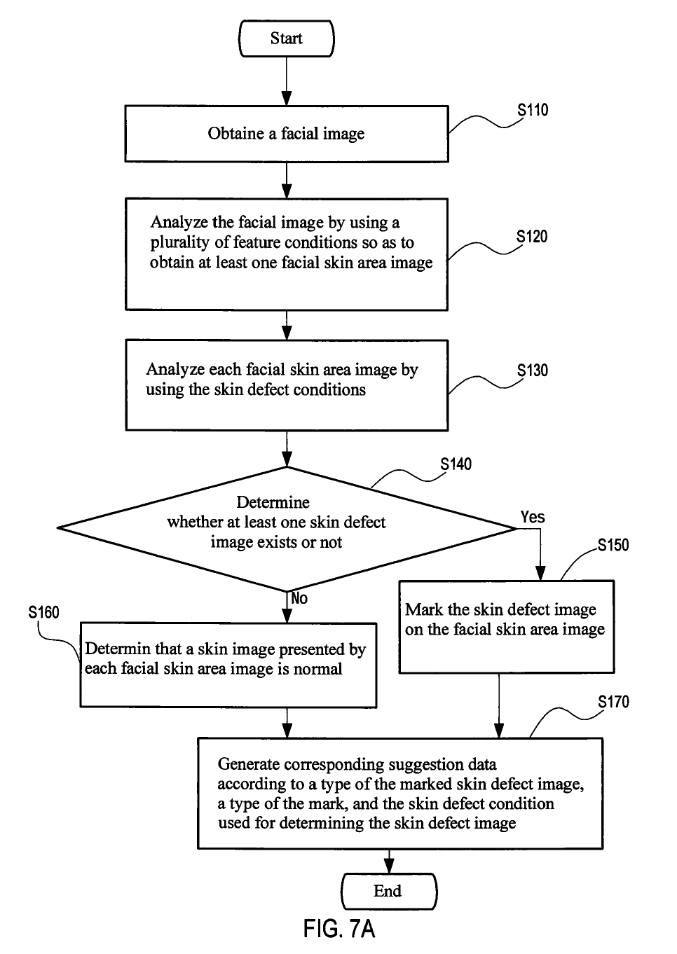

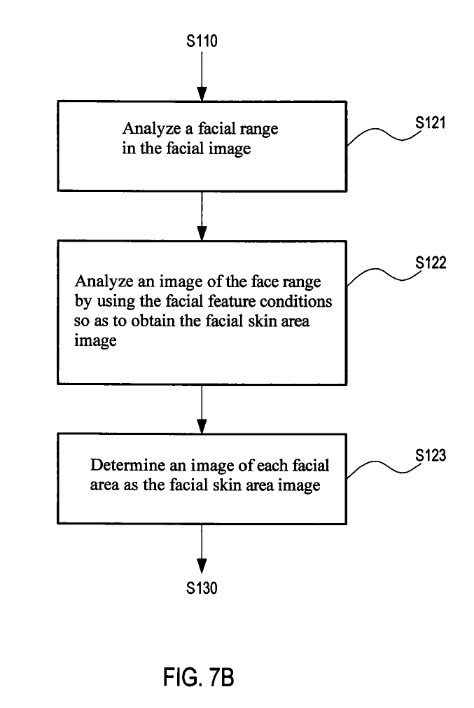

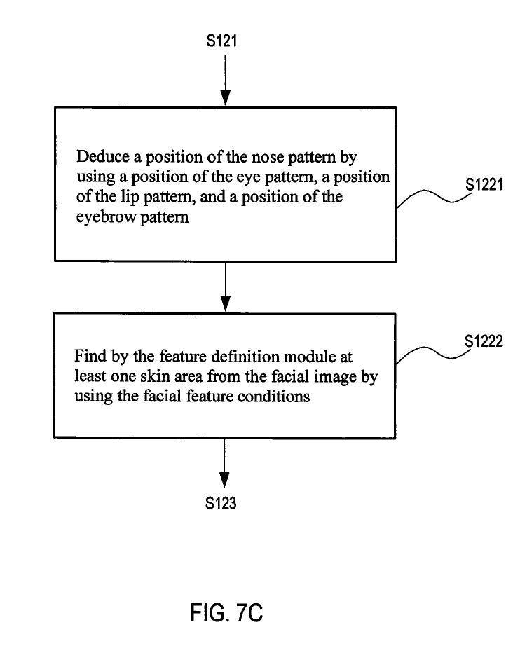

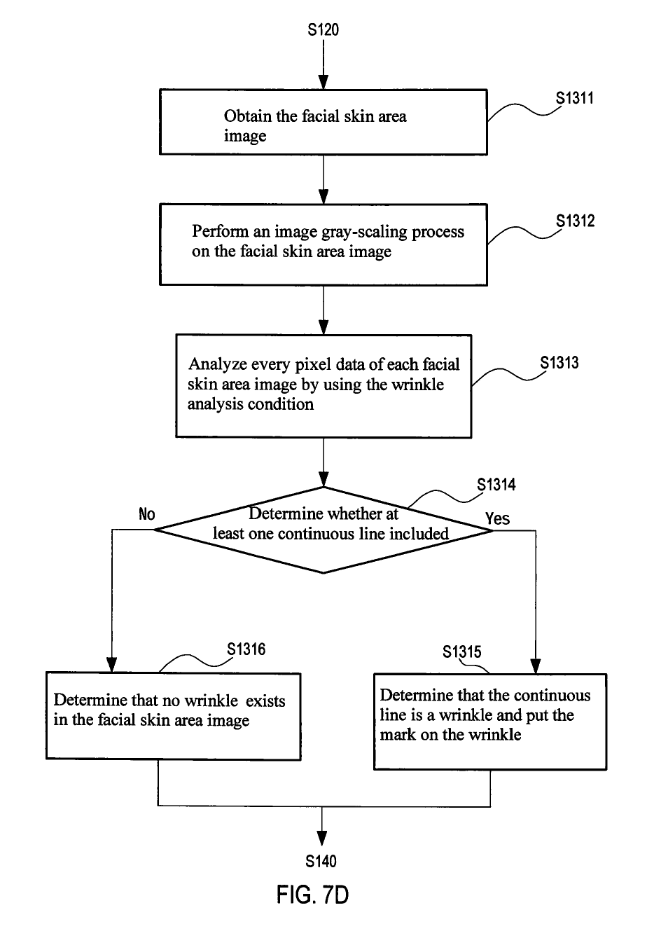

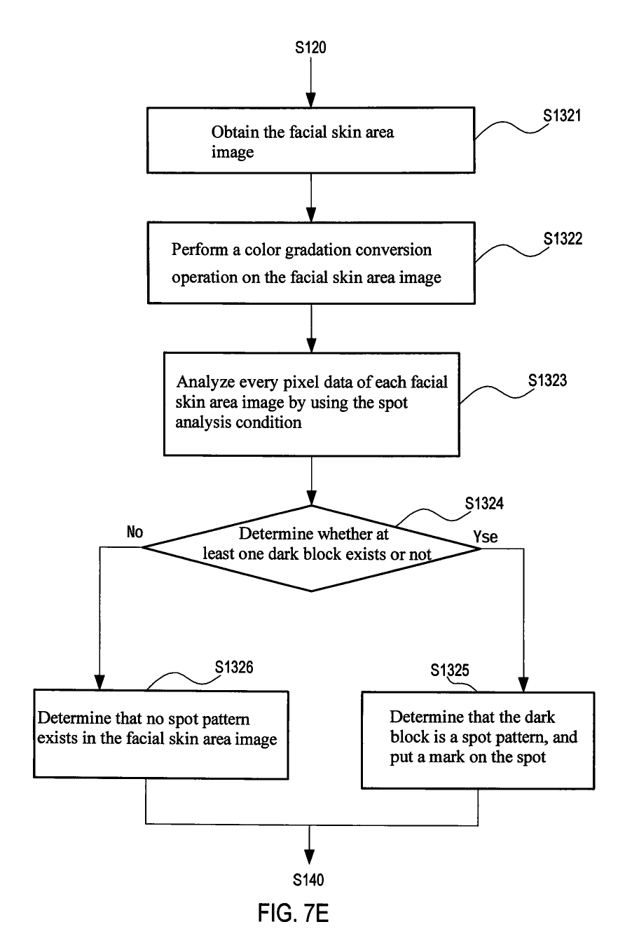

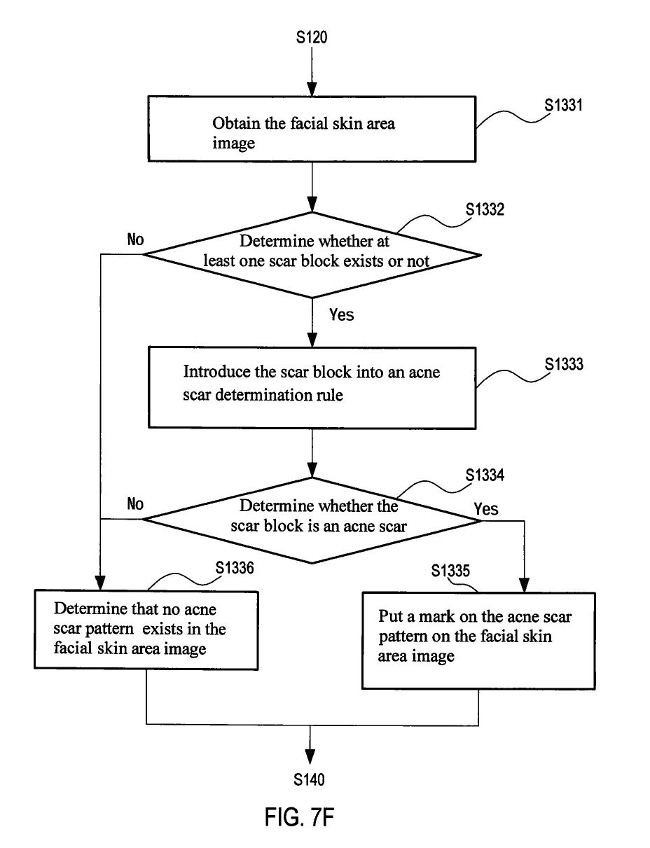

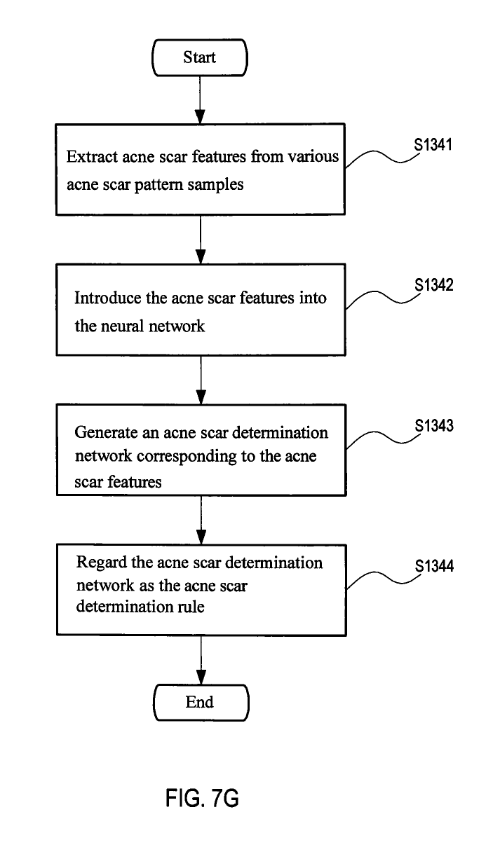

FIG. 7A is a flow chart of an embodiment of a facial skin defect resolution method in the present invention. Reference is made to FIG. 7A as well as FIGS. 1 to 6B for ease of understanding. The method is applicable to an electronic apparatus which at least includes a storage module for storing a plurality of facial feature conditions and at least one skin defect condition. In this embodiment, the electronic apparatus is illustrated as, but not limited to, the host 2. The process of the facial skin defect resolution method is illustrated below.

A facial image 7 of a user is obtained (Step S110). In the method of this embodiment, a face of a user is captured by the image pickup module 1 to form a facial image 7. The image pickup module 1 is electrically coupled to the host 2 so as to transfer the facial image 7 to the electronic apparatus and store the facial image 7 in the storage module 23.

The facial image 7 is analyzed by using at least one of all the facial feature conditions 5 so as to obtain at least one facial skin area image (Step S120). Furthermore, Step S120 may be implemented with reference to FIG. 7B which is a detailed flow chart of Step S120 in the present invention. Step S120 includes several detailed processes which are illustrated as follows.

The facial image 7 is analyzed to obtain a face range 71 (Step S121). The feature definition module 21 first finds the face range 71 of a face image of the user in the facial image 7 by using a face detection technology, and then removes the part irrelevant to the face of the user to obtain an image of the face range 71 in the facial image 7.

The image corresponding to the face range 71 is analyzed by using the facial feature conditions 5 so as to obtain the facial skin area image (Step S122). Facial features include eyes, eyebrows, a nose, and a lip, so that the facial feature conditions 5 include an eye pattern 51, a lip pattern 53, an eyebrow pattern 52, and a nose pattern 54.

Furthermore, Step S122 may be implemented with reference to FIG. 7C which is a detailed flow chart of Step S122 in the present invention. Firstly, the feature definition module 21 deduces a position of the nose pattern 54 by using a position of the eye pattern 51, a position of the lip pattern 53, and a position of the eyebrow pattern 52 (Step S1221). Then, the feature definition module 21 finds at least one skin area from the facial image 7 by using the facial feature conditions 5 (Step S1222). The skin area does not match all the facial feature conditions 5, and includes, for example, but is not limited to, a forehead skin area, a left cheek skin area, and a right cheek skin area. Finally, the feature definition module 21 determines that an image of each facial area is the facial skin area image (Step S123), for example, the aforementioned forehead skin area image 61, the left cheek skin area image 62, and the right cheek skin area image 63.

Each facial skin area image is analyzed by using the skin defect conditions (Step S130). The skin analysis module 22 analyzes the facial skin area images by using the skin defect condition pre-stored in the storage module 23 so as to determine whether at least one skin defect image exists in each facial skin area image. The skin defect condition in this embodiment includes, but is not limited to, at least one selected from a group consisting of the wrinkle analysis condition 41, the spot analysis condition 42, and the acne scar analysis condition 43. Other relevant skin defect situations are also applicable.

FIG. 7D is a flow chart of a wrinkle analysis embodiment in the present invention. The skin analysis module 22 first obtains the facial skin area image (Step S1311), and then performs an image gray-scaling process on the facial skin area image (Step S1312). Afterwards, the skin analysis module 22 performs a furrow edge detection operation, that is, analyzes every pixel data of each facial skin area image by using the wrinkle analysis condition 41 (Step S1313). As for the forehead skin area image 61, the skin analysis module 22 analyzes the forehead skin area image 61 to see whether a plurality of dark pixels exist and the dark pixels form at least one continuous line.

Afterwards, the skin analysis module 22 determines whether the facial skin area image includes at least one continuous line (Step S1314), and if yes, determines that the continuous line is the wrinkle 611 and puts the mark 81 on the wrinkle 611 (Step S1315); otherwise, determines that no wrinkle 611 exists in the facial skin area image (Step S1316).

FIG. 7E is a flow chart of a spot analysis embodiment in the present invention. The skin analysis module 22 first obtains the facial skin area image (Step S1321), and then performs a color gradation conversion operation on the facial skin area image (Step S1322), in which a skin color presented by the facial skin area image is compared with a skin sample image and a glossiness of the facial skin area image is adjusted to make the skin color presented by the facial skin area image conform to the skin sample image, thereby preventing the facial skin area image from presenting a skin color different from the skin sample image due to the influence of the optical brightness of the photographing environment and avoiding interference with the analysis operation of the skin defect.

Afterwards, the skin analysis module 22 performs an adaptive threshold comparison operation, that is, analyzes every pixel data of each facial skin area image by using the spot analysis condition 42 (Step S1323) and tries to find out whether a plurality of dark pixels exist in the facial skin area image and the dark pixels form at least one dark block (Step S1324). As for the left cheek skin area image 62, the skin analysis module 22 analyzes the left cheek skin area image 62 to see whether the dark block exists or not.

If the dark block exists, it is determined that the dark block is the spot pattern 621, and the mark 82 is put on the spot pattern 621 (Step S1325); otherwise, it is determined that no spot pattern 621 exists in the facial skin area image (Step S1326).

It should be noted herein that, the dark pixel presents a skin luster deeper than that of the normal skin color, and has a degree of luster higher than an adaptive threshold. However, the adaptive threshold is a system default value or preset by an operator via a man-machine interface of the system.

FIG. 7F is a flow chart of an acne scar analysis embodiment in the present invention. The skin analysis module 22 first obtains the facial skin area image (Step S1331), and then determines whether a plurality of abnormal pixel data exists and the abnormal pixel data form at least one scar block (Step S1332). As for the right cheek skin area image 63, the skin analysis module 22 analyzes the right cheek skin area image 63 to see whether the scar block exists.

If the scar block exists, the scar block is introduced into an acne scar determination rule (Step S1333) so as to determine whether the scar block is the acne scar pattern 631 (Step S1334). If yes, the mark 83 is put on the acne scar pattern 631 on the facial skin area image (Step S1335). On the contrary, if the skin analysis module 22 determines that no scar block exists in Step S1332 and that the scar block is not the acne scar pattern 631 in Step S1334, it is determined that no acne scar pattern 631 exists in the facial skin area image (Step S1336).

It should be noted herein that, the abnormal pixel data includes color data different from that included in normal pixel data, that is, the abnormal pixel data presents a skin luster different from that of the normal skin color.

The acne scar pattern 631 has no particular shape or luster. In order to improve the accuracy of the acne scar determination rule, the acne scar determination rule is established by a plurality of acne scar pattern samples in combination with a neural network. FIG. 7G is a schematic view illustrating establishment of the acne scar determination rule in the present invention. Firstly, acne scar features are extracted from various acne scar pattern samples (Step S1341). The acne scar features are introduced into the neural network (Step S1342). Detection is performed on the acne scar features by using self-learning, inductive inference, parallel computation, and other characteristics of the neural network, so as to generate an acne scar determination network corresponding to the acne scar features (Step S1343), and the acne scar determination network is regarded as the acne scar determination rule (Step S1344). The skin analysis module 22 determines whether the scar block is the acne scar pattern 631 upon introducing the scar block into the acne scar determination network.

It is determined whether at least one skin defect image exists or not (Step S140). The skin analysis module 22 determines whether any one of the wrinkle 611, the spot pattern 621, and the acne scar pattern 631 exists in the facial skin area image. When the analyzed facial skin area image includes at least one skin defect image, the skin defect image in the facial skin area image is marked (Step S150). As shown in FIGS. 4A and 4B, if the skin analysis module 22 determines that the skin defect image included in the facial skin area image is the wrinkle 611, the skin analysis module 22 draws a line of another luster for the wrinkle 611 so as to put the mark 81 on the wrinkle 611. As shown in FIGS. 5A and 5B, if the skin analysis module 22 determines that the skin defect image included in the facial skin area image is the spot pattern 621, the skin analysis module 22 puts the mark 82 on the spot pattern 621 so as to highlight the position of the spot pattern 621. As shown in FIGS. 6A and 4B, if the skin analysis module 22 determines that the skin defect image included in the facial skin area image is the acne scar pattern 631, the skin analysis module 22 puts the mark 83 on the acne scar pattern 631 so as to highlight the position of the acne scar pattern 631.

When the at least one skin defect image does not exist, it is determined that a skin image presented by each facial skin area image is normal (Step S160). That is, if the skin analysis module 22 determines that none of the facial skin area image has the pattern satisfying the skin defect condition, the skin analysis module 22 does not put any mark on the facial skin area image and determines that the facial skin of the user corresponding to the facial skin area image has no defect.

In addition, the storage module 23 further stores at least one suggestion data 9 corresponding to the relevant skin defect condition, and the system further includes a suggestion module 24 that generates the corresponding suggestion data 9 according to the marked skin defect image, a type of the skin defect image, a type of the mark, and the skin defect condition used for determining the skin defect image (Step S170).

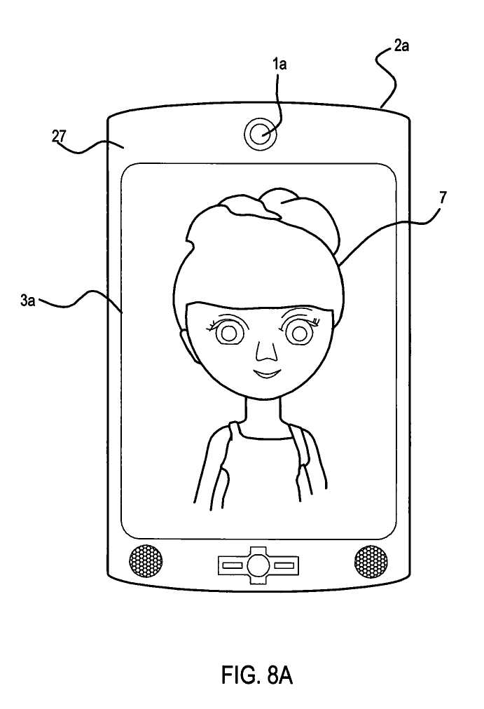

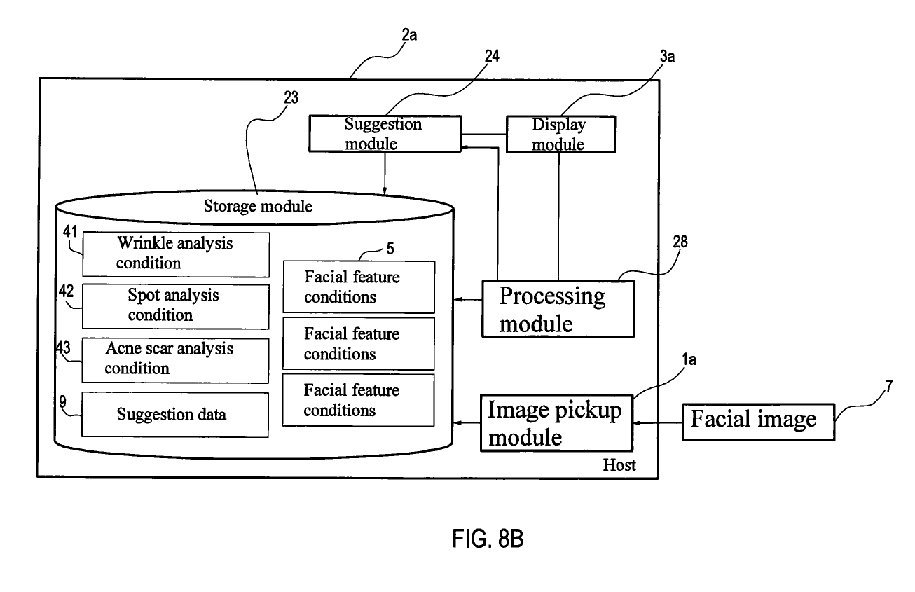

FIG. 8A is a schematic architectural view of a facial skin defect resolution device in an embodiment of the present invention, and FIG. 8B is a schematic block diagram of the facial skin defect resolution device in the embodiment of the present invention. Reference is made to FIGS. 8A and 8B as well as FIGS. 1A to 7G for ease of understanding. The facial skin defect resolution device 2a is illustrated as, but not limited to, a handheld electronic device (for example, a digital cell phone, a PDA, or other types of handheld devices). The facial skin defect resolution device 2a includes a case 27, an image pickup module 1a, a storage module 23, a processing module 28, and a display module 3a. The image pickup module 1a and the display module 3a are disposed outside the case 27, and the processing module 28 and the storage module 23 are disposed inside the case 27. The processing module 28 is electrically coupled to the storage module 23, the display module 3a, and the image pickup module 1a. The image pickup module 1a is used for capturing a face of a user to form a facial image 7. The storage module 23 stores at least one skin defect condition and at least one of a plurality of facial feature conditions 5. The processing module 28 analyzes the facial image 7 according to the facial feature conditions 5 so as to obtain at least one facial skin area image 71, and determines whether at least one skin defect image exists in each facial skin area image by using at least one skin defect condition, and if yes, puts a mark on the skin defect image in each facial skin area image 71. In addition, the storage module 23 further stores at least one suggestion data 9 corresponding to the relevant skin defect condition, and the processing module 28 further generates the corresponding suggestion data 9 according to a type of the skin defect image, a type of the mark, and the skin defect condition used for determining the skin defect image.

To sum up, the above descriptions are merely implementations or embodiments for presenting the technical means adapted to solve the problem in the present invention, but not intended to limit the scope of the invention. That is, any equivalent modification and variation made in conformity to the content of the claims of the present invention or according to the scope of the present invention shall fall within the scope of the invention.

What is claimed is:

1. A facial skin defect resolution system, comprising:
a storage module, for storing a facial image of a user, a skin defect condition, and a plurality of facial feature conditions;
a feature definition module, for analyzing the facial image according to the facial feature conditions so as to obtain a facial skin area image; and
a skin analysis module, for determining whether a skin defect image exists in the facial skin area image by using the skin defect condition, and if yes, marking the skin defect image in the facial skin area image.

2. The facial skin defect resolution system according to claim 1, further comprising:
an image pickup module for capturing a face of the user to form the facial image and the image pickup module being electrically coupled to the storage module so as to transfer the facial image to the storage module.

3. The facial skin defect resolution system according to claim 1, further comprising: a communication module for being linked to a communication network so as to receive and store the facial image into the storage module.

4. The facial skin defect resolution system according to claim 1, wherein the facial feature conditions comprise an eye pattern, a lip pattern, an eyebrow pattern, and a nose pattern, and the feature definition module finds a skin area different from the facial feature conditions from the facial image and determines that an image of the skin area is the facial skin area image.

5. The facial skin defect resolution system according to claim 1, wherein the feature definition module first analyzes the facial image to obtain a face range, and then analyzes an image corresponding to the face range by using the facial feature conditions.

6. The facial skin defect resolution system according to claim 1, further comprising: a display module for displaying the facial image and the marked skin defect image.

7. The facial skin defect resolution system according to claim 1, wherein the storage module further stores a suggestion data corresponding to the skin defect condition, and the system further comprises a suggestion module for generating the corresponding suggestion data according to the marked skin defect image and the skin defect condition used for determining the skin defect image.

8. A facial skin defect resolution method, applicable to an electronic apparatus, wherein the electronic apparatus comprises a storage module for storing a plurality of facial feature conditions and a skin defect condition, the method comprising:
obtaining a facial image of a user;
analyzing the facial image by using the facial feature conditions so as to obtain a facial skin area image;
analyzing the facial skin area image by using the skin defect condition;
determining whether a skin defect image exists or not; and
marking the skin defect image in the facial skin area image when the skin defect image exists.

9. The method according to claim 8, further comprising: providing an image pickup module for capturing a face of the user to form the facial image and the image pickup module being electrically coupled to the electronic apparatus so as to transfer the facial image to the electronic apparatus.

10. The method according to claim 8, further comprising:
linking the electronic apparatus to a communication network so as to obtain the facial image.

11. The method according to claim 8, wherein the step of analyzing the facial image by using the plurality of facial feature conditions so as to obtain the a facial skin area image further comprises:
analyzing the facial image to obtain a face range; and
analyzing an image corresponding to the face range by using the facial feature conditions so as to obtain the facial skin area image.

12. The method according to claim 8, wherein the facial feature conditions comprise an eye pattern, a lip pattern, an eyebrow pattern, and a nose pattern, and the step of analyzing the facial image to obtain the facial skin area image further comprises:
finding a skin area different from the facial feature conditions from the facial image; and
determining that an image of the skin area is the facial skin area image.

13. The method according to claim 8, further comprising: providing a display module for displaying the facial image and the marked skin defect image.

14. The method according to claim 8, wherein the storage module further stores a suggestion data corresponding to the skin defect condition, and the method further comprises:
generating the corresponding suggestion data according to the marked skin defect image and the skin defect condition used for determining the skin defect image.

15. A facial skin defect resolution device, comprising:
a case;
an image pickup module, disposed outside the case for capturing a face of a user to form a facial image;
a storage module, disposed inside the case for storing a skin defect condition and a plurality of facial feature conditions;
a processing module, disposed inside the case and electrically coupled to the image pickup module and the storage module, for analyzing the facial image according to the facial feature conditions so as to obtain a facial skin area image, and determining whether a skin defect image exists in the facial skin area image by using the skin defect condition, and if yes, marking the skin defect image in the facial skin area image; and
a display module, disposed outside the case and electrically coupled to the processing module for displaying the facial image and the mark.

16. The device according to claim 15, wherein the storage module further stores a suggestion data corresponding to the skin defect condition, and the processing module further generates the corresponding suggestion data according to the marked skin defect image and the skin defect condition used for determining the skin defect image.

17. A computer program product, for being read by an electronic apparatus to perform a facial skin defect resolution method, wherein the electronic apparatus at least comprises a storage module for storing a plurality of facial feature conditions and a skin defect condition, and the method comprises:
obtaining a facial image of a user;
analyzing the facial image by using the facial feature conditions so as to obtain a facial skin area image;
analyzing the facial skin area image by using the skin defect condition;
determining whether a skin defect image exists; and
marking the skin defect image in the facial skin area image when the skin defect image exists.

18. The computer program product according to claim 17, wherein the method further comprises:
analyzing the facial image to obtain a face range; and
analyzing an image corresponding to the face range by using the facial feature conditions so as to obtain the facial skin area image.

19. The computer program product according to claim 17, wherein the facial feature conditions comprise an eye pattern, a lip pattern, an eyebrow pattern, and a nose pattern, and the method further comprises:
finding a skin area different from the facial feature conditions from the facial image; and
determining that an image of the skin area is the facial skin area image

20. The computer program product according to claim 17, wherein the storage module further stores a suggestion data corresponding to the skin defect condition, and the method further comprises:
generating the corresponding suggestion data according to the marked skin defect image and the skin defect condition used for determining the skin defect image.
